(19) United States
(12) Patent Application Publication
(10) Pub. No.: US 2025/0216295 A1
(43) Pub. Date: Jul. 3, 2025

(54) Detecting Manipulation of a Sensor Value of an Exhaust Gas Sensor of an Internal Combustion Engine for a Vehicle

(71) Applicant: Vitesco Technologies GmbH, Regensburg (DE)

(72) Inventors: Erwin Achleitner, Obertraubling (DE); Paul Rodatz, Landshut (DE); Gerhard Haft, Maxhütte-Haidhof (DE); Michael Nienhoff, Regensburg (DE); Mattia Perugini, Pesaro (IT)

(73) Assignee: Vitesco Technologies GmbH, Regensburg (DE)

(21) Appl. No.: 18/852,745

(22) PCT Filed: Mar. 28, 2023
(86) PCT No.: PCT/EP2023/057946

§ 371 Date: Sep. 30, 2024

(30) Foreign Application Priority Data
Mar. 31, 2022 (DE) 10 2022 203 170.9

(51) Int. Cl. G01M 15/02; G01M 15/10

(52) U.S. Cl. CPC G01M 15/02; G01M 15/104

(57) ABSTRACT

Various embodiments of the teachings herein include methods for detecting a manipulation of a sensor value of an exhaust gas sensor of an internal combustion engine for a vehicle. An example includes: operating the internal combustion engine in an overrun cutoff mode; determining a first sensor value from an exhaust gas sensor with the throttle valve closed; establishing a suspected manipulation by evaluating the first sensor value as a function of a first threshold value; and verifying the suspected manipulation using the control device by measuring a second sensor value from the exhaust gas sensor in the event of an increase in the emissions of the internal combustion engine and evaluating the second sensor value as a function of a second threshold value if the suspected manipulation has previously been established.

### CROSS-REFERENCE TO RELATED APPLICATIONS

This application is a U.S. National Stage Application of International Application No. PCT/EP2023/057946 filed Mar. 28, 2023, which designates the United States of America, and claims priority to DE Application No. 10 2022 203 170.9 filed Mar. 31, 2022, the contents of which are hereby incorporated by reference in their entirety.

### TECHNICAL FIELD

The present disclosure relates internal combustion engines. Various embodiments of the teachings herein include systems and/or methods for detecting a manipulation of a sensor value from an exhaust gas sensor, more particularly a nitrogen oxide sensor, of an internal combustion engine for a vehicle.

### BACKGROUND

Exhaust gas sensors, such as nitrogen oxide sensors (NOx sensors), measure an exhaust gas concentration in the exhaust gas of a vehicle's combustion engine. They are used for the regulation of SCR (Selective Catalytic Reduction) systems and LNT (Lean NOx Trap) catalysts or else employed in future for OBM (OnBoard Monitoring) of exhaust gas emissions. For various reasons, attempts are repeatedly made to distort the measured values from the exhaust gas sensors, in particular from NOx sensors, and so to make out that the exhaust gas emissions are lower than those actually present.

A large number of NOx sensor emulators, for example, are now freely accessible and available on the Internet, which distort the measured values from the NOx sensors and feign a functioning exhaust gas aftertreatment system to a control unit. The aim of these emulators is, for example, to save on reducing agent for SCR catalysts or else to avoid repair costs for the exhaust gas cleaning system. Because of the many possible attack points for circumventing exhaust gas aftertreatment, discovering these emulators is not simple. Another way to distort the actual emission values is to demount the exhaust gas sensors so that they only measure ambient air. Furthermore, the protective tube of the exhaust gas sensors can also be modified so that the exhaust gas mass flow does not reach the sensor element.

Not all modifications can be detected by the self-diagnosis system of the exhaust gas sensors, such as of the nitrogen oxide sensors, by means of a so-called gain check. A simple test of a nitrogen oxide sensor by means, for example, of the comparison of the linear signal of the linear lambda probe and the linear oxygen signal in a nitrogen oxide sensor is described in patent specification DE 102008024177 B3. The method described in DE 102008024177 B3 can be used to detect a demounted sensor using a linear lambda probe and the linear lambda probe signal of the nitrogen oxide sensor. However, if the sensor value from the exhaust gas sensor itself is manipulated, for example by an emulator, this can only be detected in the system.

### SUMMARY

Teachings of the present disclosure include systems and methods for detecting a manipulation of a sensor value from an exhaust gas sensor of an internal combustion engine for a vehicle that makes it possible to reliably detect a manipulation of the sensor value output by the exhaust gas sensor while generating as low a level of emissions as possible. For example, some embodiments include a method for detecting a manipulation of a sensor value of an exhaust gas sensor of an internal combustion engine for a vehicle, wherein the internal combustion engine (1) comprises a control device (10) for controlling the internal combustion engine, an inlet tract (20) with a throttle valve (30), a combustion chamber (40) fluid-connected to the inlet tract, and an exhaust gas tract (50) fluid-connected to the combustion chamber and with a catalytic converter (60), wherein the exhaust gas sensor (70) is arranged in the exhaust gas tract (50) downstream of the catalytic converter (60), the method comprising: operating the internal combustion engine (1) in an overrun cutoff mode, determining a first sensor value (ΔNox) from the exhaust gas sensor (70) with the throttle valve (30) closed, establishing a suspected manipulation by the control device (10) by evaluating the first sensor value (ΔNox) as a function of a first threshold value (C1), and verifying the suspected manipulation by the control device (10) by measuring a second sensor value (Nox(t2′), NH3(t2′), Nox(t3′), NH3(t3′)) from the exhaust gas sensor (70) in the event of an increase in the emissions of the internal combustion engine (1) and by evaluating the second sensor value (Nox(t2′), NH3(t2′), Nox(t3′), NH3(t3′)) as a function of a second threshold value (C2), if the suspected manipulation has previously been established.

In some embodiments, the method comprises: calibrating a zero point of the exhaust gas sensor (70) after operation of the internal combustion engine (1) in the overrun cutoff mode, and determining the first sensor value (ΔNox) as a function of the calibration of the zero point of the exhaust gas sensor (70).

In some embodiments, calibrating the zero point of the exhaust gas sensor (70) includes: opening the throttle valve (30), and determining a third sensor value (Nox(t2−t1)) after a first time (t1) after the opening of the throttle valve (30).

In some embodiments, the method comprises determining the third sensor value (Nox(t2−t1)) by calculating an average of the sensor values from the exhaust gas sensor (70) between the first time (t1) and a second time (t2) after the first time (t1).

In some embodiments, determining the first sensor value (ΔNox) from the exhaust gas sensor (70), includes: closing the throttle valve (30) at a third time (t3) after the second time (t2), and determining a fourth sensor value (Nox(t4−t5)) after a period of time after the closing of the throttle valve (30).

In some embodiments, the method includes determining the fourth sensor value (Nox(t4−t5)) by calculating an average of the sensor values from the exhaust gas sensor (70) between a fourth time (t4) after the third time (t3) and a fifth time (t5) after the fourth time (t4).

In some embodiments, the first sensor value (ΔNox) is determined by calculating a difference between the fourth sensor value (Nox(t4−t5)) and the third sensor value (Nox(t2−t1)).

In some embodiments, the suspected manipulation is established by the control device (10) if the control device (10) determines that the first sensor value (ΔNox) is below the first threshold value (C1).

In some embodiments, the method includes verifying the suspected manipulation by: ending the overrun cutoff mode of the internal combustion engine (1) at a sixth time (t1′) after the fifth time (t5), operating the internal combustion engine (1) with a lean combustion air ratio after the sixth time (t1′), measuring the second sensor value (Nox(t3′)) at a seventh time (t3′) after the sixth time (t1′), and verifying the suspected manipulation if the control device (10) establishes that the second sensor value (Nox(t3′)) is below the second threshold value (C2).

In some embodiments, the method includes verifying the suspected manipulation by: ending the overrun cutoff mode of the internal combustion engine (1) at a sixth time (t1′) after the fifth time (t5), operating the internal combustion engine (1) with a lean combustion air ratio after the sixth time (t1′), measuring the second sensor value (Nox(t2′)) from a seventh time (t2′) after the sixth time (t1′) and determining an integral over a course of the second sensor value between the sixth time (t1′) and the seventh time (t2′), and verifying the suspected manipulation if the control device (10) establishes that a value of the integral is below the second threshold value (C2).

In some embodiments, the second sensor value indicates a nitrogen concentration in the exhaust gas tract (50).

In some embodiments, clearance of the catalytic converter (60) after the ending of overrun cutoff is delayed until the verification of the suspected manipulation is at an end.

In some embodiments, the method includes verifying the suspected manipulation by: ending the overrun cutoff mode of the internal combustion engine (1) at a sixth time (t1′) after the fifth time (t5), clearing the catalytic converter (60) by purging the catalytic converter for a period of time greater than a period of time necessary to consume the oxygen present in the catalytic converter, operating the internal combustion engine (1) with a rich combustion air ratio after the sixth time (t1′), measuring the second sensor value (NH3(t3′)) at a seventh time (t3′) after the sixth time (t1′), and verifying the suspected manipulation if the control device (10) establishes that the second sensor value (NH3(t3′)) is below the second threshold value (C2).

In some embodiments, the second sensor value indicates an ammonia concentration in the exhaust gas tract (50).

As another example, some embodiments include an internal combustion engine for a vehicle with detection of a manipulation of a sensor value from an exhaust gas sensor, comprising: a control device (10) for controlling the internal combustion engine (1), an inlet tract (20) with a throttle valve (30), a combustion chamber (40) fluid-connected to the inlet tract, an exhaust gas tract (50) fluid-connected to the combustion chamber (40) and with a catalytic converter (60), wherein the exhaust gas sensor (70) is arranged in the exhaust gas tract (50) downstream of the catalytic converter (60), and the control device (10) is programmed to perform one or more of the methods for detecting a manipulation of a sensor value from the exhaust gas sensor (70) as described herein.

### BRIEF DESCRIPTION OF THE DRAWINGS

The teachings herein are explained in more detail below with reference to figures showing example embodiments of the teachings. In the figures:

FIG. 1 shows a schematic view of an internal combustion engine of a vehicle;

FIG. 2 shows a flow diagram of a first stage of a method for detecting a manipulation of a sensor value from an exhaust gas sensor of an internal combustion engine incorporating teachings of the present disclosure;

FIG. 3 shows signal curves for elucidating the first stage of the method for detecting a manipulation of a sensor value from an exhaust gas sensor of an internal combustion engine incorporating teachings of the present disclosure;

FIG. 4 shows a first embodiment of a second stage of a method for detecting a manipulation of a sensor value from an exhaust gas sensor of an internal combustion engine incorporating teachings of the present disclosure;

FIG. 5 shows signal curves for elucidating the first embodiment of the second stage of the method for detecting a manipulation of a sensor value from an exhaust gas sensor of an internal combustion engine incorporating teachings of the present disclosure;

FIG. 6 shows a further embodiment of a second stage of a method for detecting a manipulation of a sensor value from an exhaust gas sensor of an internal combustion engine incorporating teachings of the present disclosure; and

FIG. 7 shows signal curves for elucidating the further embodiment of the second stage of a method for detecting a manipulation of a sensor value from an exhaust gas sensor of an internal combustion engine incorporating teachings of the present disclosure.

### DETAILED DESCRIPTION

The methods described herein may be used with an internal combustion engine which has a control device for controlling the internal combustion engine, an inlet tract with a throttle valve, a combustion chamber fluid-connected to the inlet tract, and an exhaust gas tract fluid-connected to the combustion chamber and with a catalytic converter. The exhaust gas sensor is arranged in the exhaust gas tract downstream of the catalytic converter.

In some embodiments, the internal combustion engine is initially operated in an overrun cutoff mode. When the throttle valve is closed, a first sensor value from the exhaust gas sensor is determined. By the control device, a suspected manipulation can first be established by evaluating the first sensor value as a function of a first threshold value. If the suspected manipulation has been established, the control device verifies the suspected manipulation by measuring a second sensor value from the exhaust gas sensor in the event of an increase in the emissions of the internal combustion engine and evaluating the second sensor value as a function of a second threshold value.

A two-stage method is employed. In the first stage, in which first a suspected manipulation is established, no additional emissions are generated, as the internal combustion engine is operated in an overrun cutoff mode. Only when a suspicion of manipulation arises in the first stage of the method, the suspected manipulation is verified in the second stage of the method, with an increase in the emissions of the internal combustion engine. The verification can be carried out, for example, by checking in the second stage of the method the spread (gain) of the exhaust gas sensor signal, for example of the NOx sensor signal.

In some embodiments, in the first stage of the method, a zero point of the exhaust gas sensor is calibrated after the operation of the internal combustion engine in the overrun cutoff mode. The first sensor value is determined as a function of the calibration of the exhaust gas sensor zero point. Owing to aging effects and/or contamination effects, the measurement accuracy of the exhaust gas sensor may decrease over time. By the proposed calibration, a zero point of the exhaust gas sensor, which corresponds to a sensor value if substantially pollutant-free, in particular nitrogen dioxide-free, gases are flowing past the sensor, can be reset. The sensor values determined subsequently then refer to the newly learned zero point.

In some embodiments, the throttle valve is first opened to calibrate the zero point of the exhaust gas sensor. A third sensor value is determined after a first time after the opening of the throttle valve. By the opening of the throttle valve, the ambient pressure is set in the intake tract, thereby increasing the air mass drawn in. Since the internal combustion engine is in the overrun cutoff mode, in which no fuel is burned, the air drawn in by the inlet tract is essentially transported through the combustion chamber into the exhaust gas tract, as the internal combustion engine is dragged and moved due to the vehicle movement. At the same time, the influence of so-called blow-by gases, which can enter the intake tract through a crankcase ventilation line, remains small. Therefore, after the first time after the opening of the throttle valve, mainly ambient air flows past the exhaust gas sensor.

In some embodiments, the third sensor value is determined by calculating an average of the sensor values of the exhaust gas sensor between the first time and a second time after the first time. By the averaging, errors in the determination of the zero point can be minimized.

In some embodiments, for determining the first sensor value from the exhaust gas sensor in the first stage of the method, the throttle valve is closed again at a third time after the second time. A fourth sensor value is determined after a period of time after the closing of the throttle valve. The closing of the throttle valve increases the ratio of blow-by gases to fresh air in the exhaust gas tract of the internal combustion engine. Thus, a high proportion of blow-by gases from a crankcase of the internal combustion engine flows through the crankcase ventilation into the intake tract and from there into the exhaust gas tract due to the dragging motion of the engine. As a result, the nitrogen emissions in the exhaust gas tract increase again after the closing of the throttle valve. If no manipulation of the exhaust gas sensor has taken place, the fourth sensor value determined must indicate the increase in the nitrogen emissions.

In some embodiments, the fourth sensor value is calculated by calculating an average of the sensor values from the exhaust gas sensor between a fourth time after the third time and a fifth time after the fourth time. The averaging minimizes errors in determining the fourth sensor value. According to a further embodiment of the method, the first sensor value is determined by calculating a difference between the fourth sensor value and the third sensor value. By evaluating the difference between the fourth sensor value and the third sensor value, a suspicion of possible sensor manipulation can be established.

In some embodiments, the suspected manipulation is established by the control device if the control device determines that the first sensor value is below the first threshold value. Since the first sensor value corresponds to the previously calculated difference between the fourth sensor value and the third sensor value, a suspected manipulation is established by the control device if the difference between the fourth sensor value and the third sensor value is less than the first threshold value. If the suspected manipulation is established by the control device, the second stage of the method is executed, in which the suspected manipulation is verified.

In some embodiments, for verifying the suspected manipulation, the overrun cutoff operation of the internal combustion engine is ended at a sixth time after the fifth time. After the sixth time, the internal combustion engine is operated with a lean combustion air ratio. The second sensor value is measured according to this embodiment of the method at a seventh time after the sixth time. The suspected manipulation is verified if the control device establishes that the second sensor value is below the second threshold value.

At the seventh time, the raw emissions of the internal combustion engine are measured, as the catalytic converter is operated lean and is saturated with oxygen. Hence no NOx conversion takes place in the catalytic converter. Therefore, if the sensor is faultless, the second sensor signal must be above the second threshold value at the seventh time. If, conversely, the second sensor value is below the second threshold value, the control device establishes the manipulation of the exhaust gas sensor.

In some embodiments, an integral over a course of the second sensor value is evaluated for verifying the suspected manipulation. After a suspected manipulation has been established in the first stage of the method, the overrun cutoff operation of the internal combustion engine is first ended at a sixth time after the fifth time in order to verify the suspected manipulation. After the sixth time, the internal combustion engine is operated with a lean combustion air ratio. The second sensor value is measured from a seventh time after the sixth time and an integral over a course of the second sensor value is determined between the sixth time and the seventh time. The suspected manipulation is verified if the control device establishes that a value of the integral is below the second threshold value. In this embodiment, the sensor signal from the exhaust gas sensor is not evaluated at a specific time, but instead an integral of the sensor signal over a period of time is evaluated. This makes the measurement more independent of noise signals.

In the previously described method variants for verifying the suspected manipulation, a nitrogen concentration in the exhaust gas tract is determined with the second sensor value. Clearance of the catalytic converter after the ending of overrun cutoff is deliberately delayed until the verification of the suspected manipulation is at an end. The catalytic converter thus remains saturated with oxygen even after ending of the overrun cutoff operation of the internal combustion engine. Therefore, no nitrogen oxide conversion takes place in the catalytic converter, and so with an unmanipulated sensor, the second sensor value or the integral over the NOx curve of the second sensor value must be above a threshold value.

In some embodiments, for verifying the suspected manipulation, the overrun cutoff operation of the internal combustion engine is first ended at a sixth time after the fifth time. However, the clearance of the catalytic converter is not delayed, but instead the catalytic converter is cleared by purging the catalytic converter for a period of time greater than a period of time necessary to consume the oxygen present in the catalytic converter. After the sixth time, the internal combustion engine is operated with a rich combustion air ratio. The second sensor value is measured at a seventh time after the sixth time. The suspected manipulation is verified if the control device establishes that the second sensor value is below the second threshold value.

While the nitrogen oxide concentration (NOx concentration) in the exhaust gas determined by the exhaust gas sensor is evaluated in the previously described embodiments for verifying the suspected manipulation, an ammonia concentration (NH3 concentration) in the exhaust gas is measured and evaluated in the latter embodiment of the method for verifying the suspected manipulation. If the catalytic converter is operated with an empty oxygen reservoir in the rich operating range, ammonia is produced, with the ammonia concentration being dependent on the lambda, the temperature, and the aging state of the catalytic converter. The exhaust gas sensor, in particular a NOx exhaust gas sensor, has a cross-sensitivity to ammonia. If the catalytic converter is operated in an operating range in which ammonia is produced, the exhaust gas sensor must indicate this concentration in the exhaust gas flow.

As an example, some embodiments may include an internal combustion engine with a control device for controlling the internal combustion engine, an inlet tract with a throttle valve, a combustion chamber fluid-connected to the inlet tract, and an exhaust gas tract fluid-connected to the combustion chamber and with a catalytic converter. The exhaust gas sensor is arranged in the exhaust gas tract downstream of the catalytic converter. The control device is embodied to perform one or more of the methods for detecting a manipulation of a sensor value from the exhaust gas sensor described herein. An internal combustion engine of this kind makes it possible to establish a suspicion of manipulation of a sensor value from an exhaust gas sensor in a first stage, without additional emissions being generated by the internal combustion engine. Only if a suspicion emerges of a manipulation of the sensor value from the exhaust gas sensor, verification of the suspected manipulation by generation of additional emissions takes place in a second stage of the method executed by the control device.

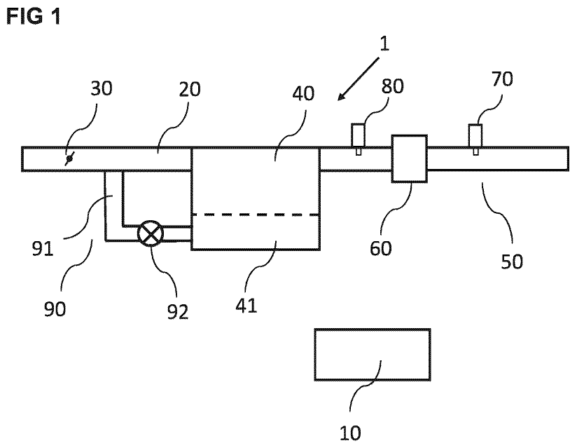

FIG. 1 shows a schematic view of an internal combustion engine 1 for a vehicle, which has a functionality for detecting a manipulation of a sensor value from an exhaust gas sensor 70, in particular a nitrogen oxide sensor (NOx sensor) incorporating teachings of the present disclosure. The internal combustion engine 1 comprises a control device 10 for controlling the internal combustion engine and its components. Furthermore, the internal combustion engine 1 has an inlet tract 20, for example an intake pipe, in which a throttle valve 30 is arranged. A combustion chamber 40 with cylinders in which pistons move is fluid-connected to the inlet tract 20. The pistons are at least partially arranged in a crankcase 41 and mechanically coupled to a crankshaft therein. Intake air can enter the combustion chamber 40 via the inlet tract 20, the intake air being mixed with fuel and burned in said chamber.

The internal combustion engine 1 further comprises an exhaust gas tract 50, which is fluid-connected to the combustion chamber 40. Arranged in the exhaust gas tract 50 is a catalytic converter 60 and, downstream of the catalytic converter 60, the exhaust gas sensor 70, in particular a nitrogen oxide sensor. Between the combustion chamber 40 and the catalytic converter 60, a lambda probe 80 may be arranged in the exhaust gas tract 50.

During the operation of the internal combustion engine 1, exhaust gases from the cylinders of the combustion chamber 40 enter the crankcase 41. In order not to eject these so-called blow-by gases into the atmosphere untreated, a venting apparatus 90 is provided with a venting line 91, which connects the crankcase 41 to the inlet tract 20. The venting apparatus 90 further comprises a venting valve 92, with which the venting of the crankcase 41 into the inlet tract 20 can be controlled.

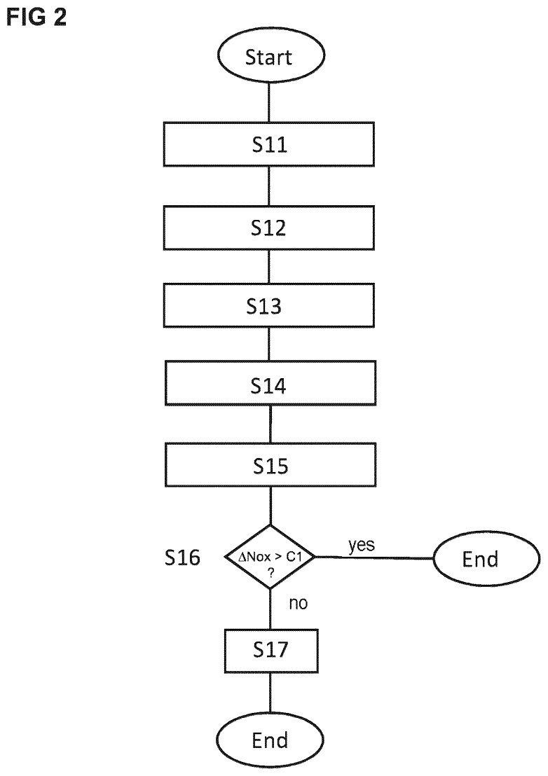

In the text below, an example method incorporating teachings of the present disclosure for detecting a manipulation of a sensor value from the exhaust gas sensor 70, in particular a nitrogen oxide sensor, is explained in more detail with reference to FIGS. 2 to 6. Nox(t) refers below to a nitrogen oxide concentration at time t, and NH3(t) refers to an ammonia concentration at time t. The individual method steps and also the control of the necessary components of the internal combustion engine 1 is carried out by means of the control device 10.

The example method comprises a two-stage procedure. In the first stage of the method, the control device 10 first checks whether there is a suspected manipulation. For this purpose, the internal combustion engine 1 is operated in an overrun cutoff mode. In the overrun cutoff mode of the internal combustion engine, an intended, temporary interruption of the fuel supply to the internal combustion engine occurs if the engine is not intended to deliver power but is instead dragged by the vehicle mass in momentum. Since the internal combustion engine is dragged and moved due to the vehicle movement, the air drawn in through the inlet tract 20 passes through the combustion chamber 40 into the exhaust gas tract 50.

In this so-called overrun mode of the internal combustion engine, a first sensor value ΔNOx of the exhaust gas sensor 70 is determined with the throttle valve 30 closed. When the throttle valve is closed, blow-by gases pass from the crankcase 41 through the crankcase ventilation line 91 into the inlet tract 20 of the internal combustion engine. This increases the ratio of blow-by gases to fresh air. As a result of the dragging motion of the engine, the blow-by gases pass from the inlet tract 20 through the combustion chamber 40 into the exhaust gas tract 50 and flow there past the exhaust gas sensor/NOx sensor 70.

For a non-manipulated exhaust gas sensor 70, the first sensor value obtained ΔNOx should indicate an increase in the nitrogen oxide concentration. In the first stage of the method, a suspected manipulation can therefore be established by evaluating the sensor value ΔNOx as a function of a threshold value C1 by the control device 10. The suspected manipulation is established in particular when the evaluated sensor value ΔNOx is below the threshold value C1.

In the second stage of the method, the suspected manipulation is then verified by the control device 10. The second stage of the method is based on a gain check of the (Nox) exhaust gas sensor 70 with increased emissions of the internal combustion engine, if a suspicion of manipulation has been established in the first method stage.

For this purpose, the overrun cutoff operation of the internal combustion engine is ended and the engine is operated in normal mode. In normal operation, fuel and fresh air are supplied to the internal combustion engine and the air/fuel mixture is burned in the combustion chamber 40. In the second stage of the method, the emissions of the internal combustion engine are thus increased, in contrast to the first stage, in which no additional emissions were generated. In the second stage of the method, a sensor value NOx(t2′) or NH3(t2′) is measured for increased emissions by the internal combustion engine.

As further explained below, the sensor value measured in the second stage of the method may be a nitrogen oxide concentration NOx(t2′) or an ammonia concentration NH3(t2′). By evaluating the measured sensor value NOx(t2′) or NH3(t2′) as a function of a second threshold value C2, a previously established suspected manipulation can be verified by the control device 10. Manipulation is present particularly when the measured second sensor value NOx(t2′) or NH3(t2′) is below the second threshold value C2.

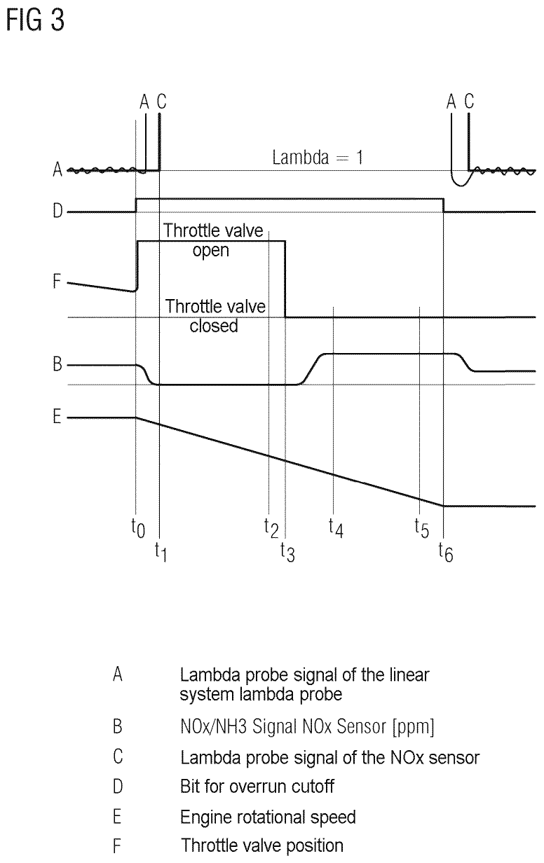

The individual method steps of the two-stage method are considered in more detail below. FIG. 2 represents the method steps during the first stage of the procedure. The various times are represented in FIG. 3.

After the start of the method, the internal combustion engine is first switched from a normal mode to the overrun cutoff mode in a step S11 at a time t0 (FIG. 3) by the control device 10 and operated in that mode thereafter. The overrun cutoff mode describes an operating state of the internal combustion engine in which no fuel is burned. Instead, the internal combustion engine is dragged and moved due to the movement of the vehicle, so that the air drawn in through the inlet tract 20 flows through the combustion chamber 40 into the exhaust gas tract 50.

In order to execute the further elements, in the method step S11 the control device 110 furthermore checks whether the speed of the vehicle is above a threshold value, for example above a threshold value of 50 km/h, and the engine speed is over a further threshold value, for example over 1800 revolutions per minute. Only if these conditions are met is it ensured that the further method steps can be executed before the vehicle comes to a standstill and are not discontinued by resumption of normal operation of the internal combustion engine, i.e. fuel supply with combustion of the air/fuel mixture, after overrun is switched off. When the exhaust gas sensor 70 is arranged in the exhaust gas tract 50 after a gas particle filter, the method step S11 additionally checks whether the temperature of the gas particle filter is lower than a threshold value, for example lower than 550° C., in order to avoid soot oxidation.

In method step S12, the exhaust gas sensor is calibrated at the time t1 (FIG. 3) by determination of a zero point of the exhaust gas sensor after operation of the internal combustion engine in the overrun cutoff mode (zero point adaptation). As a result, a signal shift in the sensor signal from the exhaust gas sensor 70, arising from aging effects and/or contamination effects of the exhaust gas sensor, can be compensated. The exhaust gas sensor 70 is thus calibrated with respect to its actual zero point in method step S12. The sensor value ΔNOx can therefore be determined later in an error-compensated manner, as a function of the calibration of the zero point of the exhaust gas sensor 70.

To calibrate the zero point of the exhaust gas sensor 70, in method step S12, the throttle valve 30 is opened at the time t1, so that ambient pressure is set in the inlet tract or suction pipe 20 and the air mass drawn in is increased. At the time t1 or after a period of time t1 after the opening of the throttle valve 30 at the time t0, it can be assumed that fresh air has safely arrived at the exhaust gas sensor 70 by the dragging movement of the engine and that the sensor signal from the exhaust gas sensor 70 has stabilized. Typical values of a period of time from the starting of overrun operation at the time t0 to the time t1 are approximately 3-5 seconds and depend on the volume of the exhaust gas system.

After the opening of the throttle valve 30, a sensor value NOx(t2−t1) is determined after the time t1. The sensor value NOx(t2−t1) is preferably calculated by calculating an average of the sensor values from the exhaust gas sensor 70 between the time t1 and a time t2 after the time t1. During this time, it is mainly ambient air that flows past the exhaust gas sensor 70. The sensor value NOx(t2−t1) corresponds to the actual zero point of the exhaust gas sensor 70, which is now learned by the control device 10. If the average of the newly learned zero point of the sensor signal from the exhaust gas sensor 70 is greater than the sensor tolerance, for example 10 ppm, the zero point adaptation is implausible and is not performed. Implausible adaptation can result from burning of oil or oxidation of soot.

After calibration of the exhaust gas sensor 70, the throttle valve 30 is closed in method step S13 at a time t3 after the time t2. While the influence of blow-by gases on the exhaust gas sensor 70 during the calibration of the zero point or the zero point adaptation through the opened throttle valve is small, the ratio of blow-by gases to fresh air is increased by the closing of the throttle valve 30 at the time t3. As a result, a high proportion of blow-by gases from the crankcase 41 flows through the crankcase venting line 91 into the inlet tract 20 and from there into the exhaust gas tract 50 due to the dragging movement of the engine.

At a time t4 after the throttle valve 30 has been closed and a gas run time has elapsed, the exhaust gas sensor 70 must indicate increased nitrogen concentrations if it has not been manipulated. At or after the time t4 after the closing of the throttle valve 30, the sensor value from the exhaust gas sensor 70 is therefore determined again in a method step S14 by the control device 10. According to one preferred embodiment of the method, this sensor value NOx (t4−t5) is determined in process step S14 by calculating an average of the sensor values of the exhaust gas sensor 70 between the time t4 and a subsequent time t5.

In a method step S15, the sensor value ΔNOx is determined by calculating a difference between the sensor value NOx(t4−t5) and the sensor value NOx(t2−t1) determined during the zero point adaptation or calibration of the exhaust gas sensor by the control device 10 (ΔNOx=NOx(t5−t4)−NOx(t2−t1)).

If the exhaust gas sensor 70 has not been manipulated, the sensor value ΔNOx must be greater than a threshold value. Therefore, in method step S16, the control device 10 checks whether the sensor value ΔNOx is greater than a threshold value C1 (ΔNOx>C1?). If the control device 10 determines that the sensor value ΔNOx is greater than the threshold value C1, there is no suspicion that the sensor value, in particular the NOx sensor value, from the exhaust gas sensor 70 has been manipulated, and the method is ended. If, on the other hand, it is determined by the control device 10 that the sensor value ΔNOx is below the threshold value C1, a suspected manipulation is established by the control device 10 in method step S16.

When the suspected manipulation has been established, the second stage of the method, in which the suspected manipulation is verified, is executed in method step S17. The method is thereafter at an end.

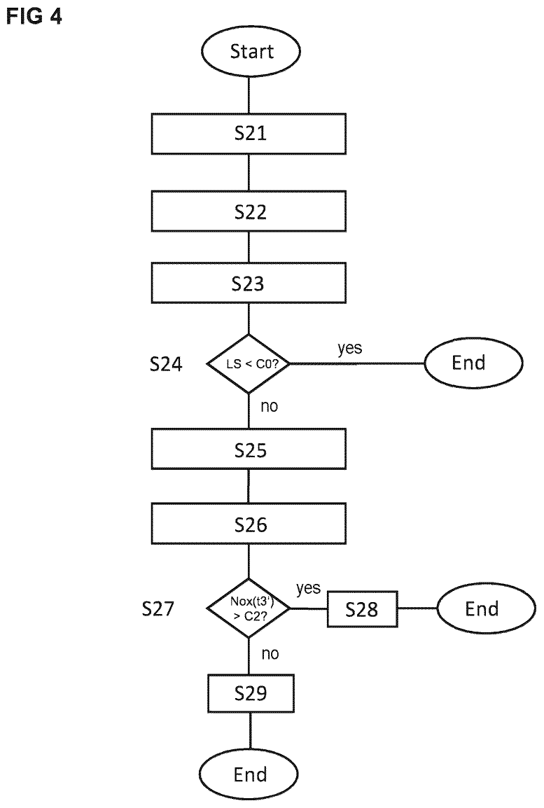

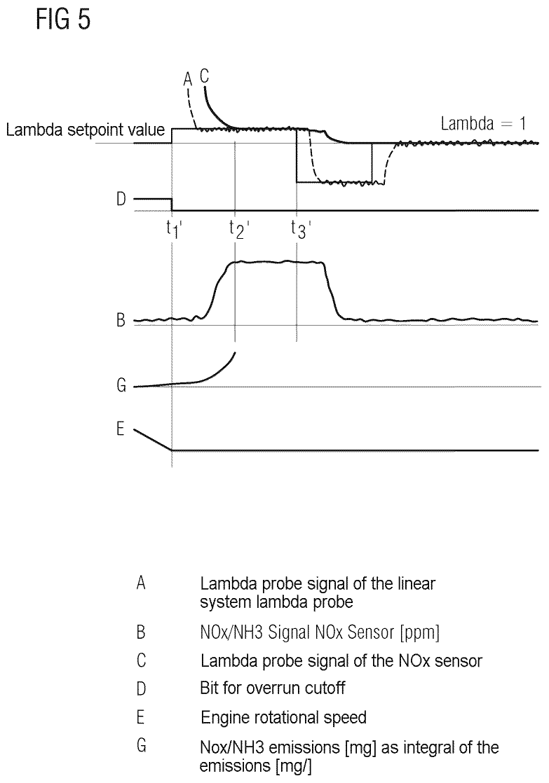

In the text below, different variant embodiments for the second stage of the method for verifying the suspected manipulation are explained in more detail with reference to FIGS. 4 to 6. The individual times for the method steps can be taken from FIG. 3 and in particular FIG. 5. The times t1′, t2′ and t3′ shown in FIG. 5 are temporally after the time t6 of FIG. 3.

The suspected manipulation established in method step S16 in the first stage of the method is verified in the second stage of the method with increased emissions of the internal combustion engine, while the first stage of the method took place by operation of the internal combustion engine in the overrun cutoff mode without emissions. The suspected manipulation is verified if, in method step S16 of the first stage of the method, the control device 10 has established that the condition ΔNOx =NOx(t5−t4)−NOx(t2−t1)<C1 is met. The suspected manipulation can then be verified, for example, when a restart speed is reached in the idling of the internal combustion engine at the time t6 (FIG. 3) after the overrun cutoff.

According to the sequence shown in FIG. 4 for the second method stage, after the start of the second stage of the method, overrun cutoff operation of the internal combustion engine 1 is ended at a time t1′ (FIG. 5) after the time t5 or t6 (FIG. 3) respectively. The internal combustion engine is therefore operated again in normal mode with fuel supply and combustion of the air/fuel mixture. At idle, the NOx emissions are still low and the mass throughput is also small.

In a method step S22, the function of catalytic converter clearance, which otherwise runs immediately after the ending of the overrun cutoff and in which the oxygen stored in the catalytic converter is expelled by short rich engine operation, is deliberately and intentionally delayed. The clearance of the catalytic converter 60 is delayed until the verification of the suspected manipulation at the time t3′ (FIG. 5) is at an end.

In a method step S23, a sensor value from a lambda probe 80, which is arranged upstream of the catalytic converter 60, and/or the lambda signal from the exhaust gas sensor 70 is measured at the time t1′. The lambda signal from the lambda probe 80 upstream of the catalytic converter 60 and/or the lambda signal from the exhaust gas sensor or NOx sensor 70 must be lean or greater than a threshold value C0.

If, therefore, the control device 10 in method step S24 determines that the sensor value LS from the lambda probe 80 and/or a lambda value LS from the exhaust gas sensor 70 is below a threshold value C0, the verification of the suspected manipulation is ended. This means that if the lambda signal from the lambda probe 80 or the lambda signal from the exhaust gas sensor 70 indicates a non-lean operating state, the function of verifying the suspected manipulation is not executed, because the internal combustion engine was in the overrun cutoff mode for too short a time and hence the catalytic converter 60 was not saturated with oxygen.

If it is established in method step S24 that the sensor value or the lambda signal LS from the lambda probe 80 and/or the sensor value or lambda value LS from the exhaust gas sensor 70 is lean at the time t1′, the internal combustion engine 1 is operated after the time t1′ in method step S25 with a lean air/fuel ratio. For this purpose, a lambda setpoint value can be set to lean at time t1′, for example to 1.06.

In a subsequent method step S26, a sensor value NOx(t3′) from the exhaust gas sensor 70 is measured at a time t3′ after the time t1′. Since the catalytic converter 60 is operated lean and is saturated with oxygen, the raw emissions of the internal combustion engine are measured at the time t3′. There is no nitrogen oxide conversion in the catalytic converter 60. If, therefore, the measured sensor value NOx(t3′) from the exhaust gas sensor 70 is not above a certain threshold value, for example of 300 ppm, at the time t3′, it can be assumed that the exhaust gas sensor or NOx sensor 70 has been manipulated. The threshold value of, for example, 300 ppm depends on the respective engine, in particular on the compression ratio, the ignition timing, an internal exhaust gas recirculation, etc., and represents the raw emission at idle.

In a method step S27, the control device 10 therefore checks whether the sensor value NOx(t3′) is above a threshold value C2 at the time t3′. If the control device 10 establishes that the sensor value NOx(t3′) is above the threshold value C2, the suspected manipulation has not been corroborated, and this is established by the control device 10 in method step S28. If, on the other hand, it is established by the control device 10 in method step S27 that the sensor value NOx(t3′) from the exhaust gas sensor 70 is below the threshold value C2, the control device 10 verifies the suspected manipulation in method step S29, and so the second stage of the method for detecting a manipulation of the sensor values from the exhaust gas sensor 70 is at an end.

To end the method, a lambda value from the exhaust gas sensor 70 is measured after the time t2′. If it is established by the control device 10 that the lambda value has reached or undershot the lambda setpoint value, the verification of the suspected manipulation by the control device 10 is ended after the method step S28 or S29. Subsequently, the catalytic converter 60 is purged by briefly rich operation of the internal combustion engine 1 in order to consume the oxygen stored in the catalytic converter. Subsequently, the internal combustion engine is operated in a stoichiometric mode.

In the example shown in FIG. 5 for the second method stage, in which the suspected manipulation is verified, the sensor or lambda signal NOx(t3′) from the exhaust gas sensor 70 reaches the lambda setpoint value at the time t3′. At the latest at the time t3′, the verification of the suspected manipulation or the gain check of the exhaust gas sensor 70 is ended and the purge function of the catalytic converter 60 is started. This is done as after a normal overrun cutoff operation by short rich lambda operation of the engine in order to consume the stored oxygen in the catalytic converter as quickly as possible and thus enable the conversion of nitrogen oxide again. In the example shown, the purging function is performed with λ=0.9, but can also be performed with an even more highly enriched mixture. After the purging function, the lambda setpoint value is regulated again to stoichiometric operation.

The method advantageously also allows the cause of manipulation to be established or at least narrowed down. If the gradient of the sensor value from the exhaust gas sensor 70 at the time t2′ has not exceeded the threshold value C1, it can be established by the control device 10 that the protective tube of the sensor has been manipulated, causing the exhaust gas to arrive at the exhaust gas sensor 70 with a delay. If, on the other hand, the control device 10 establishes that the threshold value C1 is not exceeded at all, this indicates that the exhaust gas sensor 70 has been manipulated or is defective. In this case, the exhaust gas sensor 70 may have been manipulated, for example, by a NOx emulator which halves the values from the exhaust gas sensor.

To keep the influence of emissions low, the function for verifying the suspected manipulation can also be carried out in a time- controlled manner. The NOx emissions in this case are calculated in mg/s and integrated. The procedure is initially the same as the sequence outlined in FIG. 4, up until method step S25. In method step S26, the NOx emission is integrated from the time t1′ and evaluated at the time t2′. A NOx emission can be calculated in mg/s using the exhaust gas mass and the NOx concentration in ppm.

From the time t1′, an integral of the nitrogen oxide emission is formed. In particular, the control device 10 determines an integral over a curve of the NOx emission between the time t1′ and the subsequent time t2′. In the method step S27, the control device checks whether the value of the integral at the time t2′ is greater than a threshold value C2. If the control device 10 establishes that the value of the integral is above the threshold value C2, no manipulation of the exhaust gas sensor is established in method step S28. If, on the other hand, it is established by the control device 10 that the value of the integral is below the threshold value C2, the suspected manipulation is verified by the control device 10 in method step S29. A purge function for purging the catalytic converter 60 is started when the lambda probe signal after the catalytic converter has fallen below a certain value of, for example, λ=1.2 or after a defined timespan or after a defined exhaust gas mass flow throughput.

The procedure described with reference to FIGS. 4 and 5 for implementing the second stage of the method for detecting a manipulation of a sensor value from an exhaust gas or nitrogen oxide sensor leads to an increase in the NOx emission. An alternative technique, if there is only a suspicion of manipulation of the NOx sensor signal, is to carry out the clearance of the catalytic converter to a greater extent than necessary, at the time t1′. This means that a purge function is executed for the catalytic converter even though n in the catalytic converter has already been used up.

If the catalytic converter is operated with an empty oxygen reservoir in the rich operating range, ammonia (NH3) is produced both after the overrun cutoff and in normal engine operation. The NH3 concentration depends on the lambda, the temperature and the aging state of the catalytic converter. The maximum concentration is at about λ=0.95 and drops continuously to λ=1. No NH3 is generated in lean operation.

The NOx exhaust gas sensor has a cross-sensitivity to NH3, which is also used for calculating NH3 emission. If the catalytic converter is now operated in an operating range involving production of NH3, the exhaust gas sensor 70 must also indicate this concentration. If the sensor value of the NOx sensor signal is higher than a certain threshold value, for example 50 ppm, it can be assumed that the exhaust gas sensor has not been manipulated.

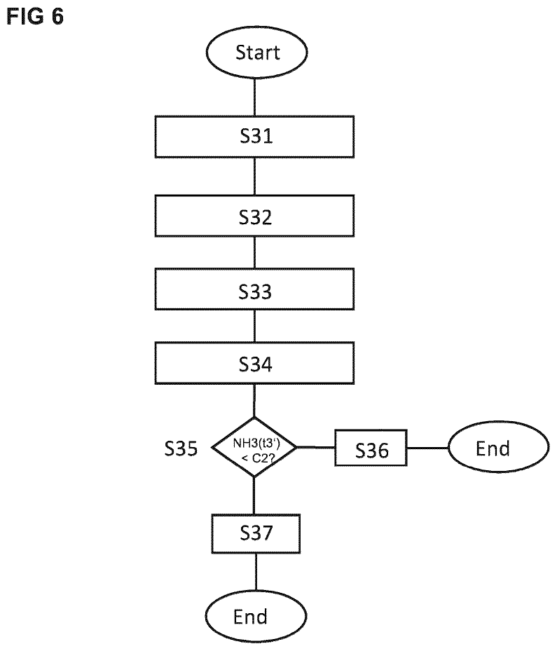

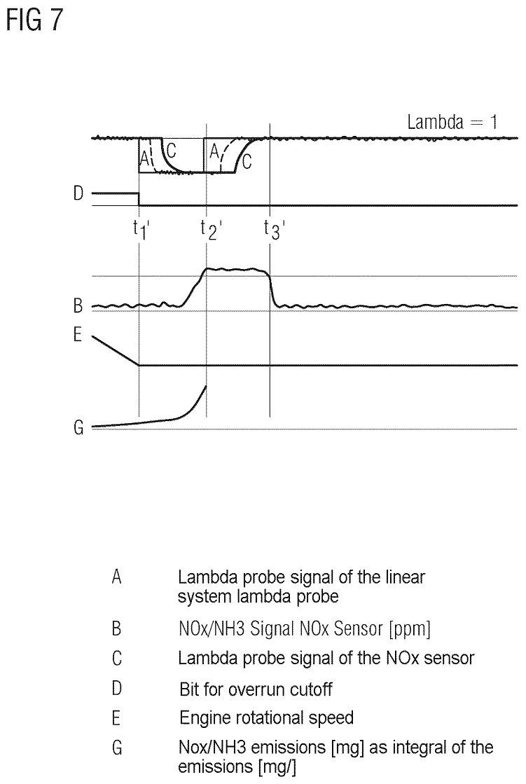

A method variant for implementing the second stage of the method, in which the NH3 emission for verifying the suspected manipulation of the sensor values from the exhaust gas sensor 70 is evaluated, is explained below with reference to the procedure outlined in FIG. 6 and to the signal curves shown in FIG. 7.

In method step S31, the overrun cutoff operation of the internal combustion engine is ended at the time t1′ after the time t5 or t6 (FIG. 3). In contrast to the procedure outlined in FIG. 4, in which the clearance of the catalytic converter 60 is delayed, the clearance of the catalytic converter 60 is intensified in method step S32, in the case of the method outlined in FIG. 6. This can be done by clearing the catalytic converter 60 for a period of time greater than a period of time necessary to consume the oxygen present in the catalytic converter.

In method step S33, the internal combustion engine 1 is operated with a rich combustion air ratio after the time t1′.

In method step S34, a sensor value NH3(t3′) is measured at the time t3′ after the time t1′. In contrast to the method outlined in FIG. 4, in which the nitrogen oxide concentration NOx is measured, the cross-sensitivity of the exhaust gas sensor 70 to NH3 is utilized in the procedure outlined in FIG. 6 and thus the NH3 concentration in the exhaust gas is measured as the sensor value NH3(t3′) at the time t3′.

In method step S35, the control device 10 checks whether the measured sensor value NH3(t3′), i.e. the NH3 concentration at the time t3′, is less than a threshold value C2. If it is established by the control device 10 that the sensor value NH3(t3′) is not below the threshold value C2 or is above the threshold value C2, the suspected manipulation is not verified by the control device 10 in method step S36. If, on the other hand, in method step S35 the control device 10 establishes that the sensor value NH3(t3′) is below the threshold value C2, the suspected manipulation is verified in method step S37 by the control device 10.

Similarly to the first embodiment of the second stage of the method, explained earlier on above, in which the NOx emission is evaluated for checking the suspected manipulation by means of an integral, an integral of the NH3 sensor value can also be evaluated in the method variant of FIGS. 6 and 7. As outlined in FIG. 7 (plot curve G), in this method variant the integral of the NH3 emission is evaluated from the time t1′ to the time t2′. If the control device 10 establishes that the value of the integral of the NH3 emission is above a threshold value C2, no manipulation of the exhaust gas sensor is established by the control device 10. If, on the other hand, it is established by the control device 10 that the value of the NH3 integral is below the threshold value C2, the suspected manipulation is verified by the control device 10.

What is claimed is:

1. A method for detecting a manipulation of a sensor value of an exhaust gas sensor of an internal combustion engine for a vehicle, wherein the internal combustion engine comprises a control device to control the internal combustion engine, an inlet tract with a throttle valve, a combustion chamber fluid-connected to the inlet tract, and an exhaust gas tract fluid-connected to the combustion chamber having a catalytic converter, wherein the exhaust gas sensor is arranged in the exhaust gas tract downstream of the catalytic converter, the method comprising:
operating the internal combustion engines in an overrun cutoff mode;
determining a first sensor value from the exhaust gas sensor with the throttle valve closed;
establishing a suspected manipulation by the control device by evaluating the first sensor value as a function of a first threshold value;
verifying the suspected manipulation using the control device by measuring a second sensor value from the exhaust gas sensor in the event of an increase in the emissions of the internal combustion engine and evaluating the second sensor value as a function of a second threshold value, if the suspected manipulation has previously been established.

2. The method as claimed in claim 1, further comprising:
calibrating a zero point of the exhaust gas sensor after operation of the internal combustion engine in the overrun cutoff mode; and
determining the first sensor value as a function of the calibration of the zero point of the exhaust gas sensor.

3. The method as claimed in claim 2, wherein calibrating the zero point of the exhaust gas sensor includes:
opening the throttle valve; and
determining a third sensor value after a first time after the opening of the throttle valve.

4. The method as claimed in claim 3, further comprising
determining the third sensor value by calculating an average of the sensor values from the exhaust gas sensor between the first time and a second time after the first time.

5. The method as claimed in claim 1, wherein determining the first sensor value from the exhaust gas sensor includes:
closing the throttle valve at a third time after the second time; and
determining a fourth sensor value after a period of time after the closing of the throttle valve.

6. The method as claimed in claim 5, further comprising:
determining the fourth sensor value by calculating an average of the sensor values from the exhaust gas sensor between a fourth time after the third time and a fifth time after the fourth time.

7. The method as claimed in claim 5, wherein determining the first sensor value includes calculating a difference between the fourth sensor value and the third sensor value.

8. The method as claimed in claim 1, wherein the suspected manipulation is established by the control device if the control device determines that the first sensor value below the first threshold value.

9. The method as claimed in claim 1, wherein verifying the suspected manipulation includes:
ending the overrun cutoff mode of the internal combustion engine at a sixth time after the fifth time;
operating the internal combustion engine with a lean combustion air ratio after the sixth time;
measuring the second sensor value at a seventh time after the sixth time; and
verifying the suspected manipulation if the control device establishes that the second sensor value is below the second threshold value.

10. The method as claimed in claim 1, wherein verifying the suspected manipulation includes:
ending the overrun cutoff mode of the internal combustion engine at a sixth time after the fifth time;
operating the internal combustion engine with a lean combustion air ratio after the sixth time;
measuring the second sensor value from a seventh time after the sixth time and determining an integral over a course of the second sensor value between the sixth time and the seventh time; and
verifying the suspected manipulation if the control device establishes that a value of the integral is below the second threshold value.

11. The method as claimed in claim 1, wherein the second sensor value indicates a nitrogen concentration in the exhaust gas tract.

12. The method as claimed in claim 1, further comprising delaying clearance of the catalytic converter after the ending of overrun cutoff until the verification of the suspected manipulation is at an end.

13. The method as claimed in a claim 1, wherein verifying the suspected manipulation includes:
ending the overrun cutoff mode of the internal combustion engine at a sixth time after the fifth time;
clearing the catalytic converter by purging the catalytic converter for a period of time greater than a period of time necessary to consume the oxygen present in the catalytic converter;
operating the internal combustion engine with a rich combustion air ratio after the sixth time;
measuring the second sensor value at a seventh time after the sixth time; and
verifying the suspected manipulation if the control device establishes that the second sensor value is below the second threshold value.

14. The method as claimed in claim 1, wherein the second sensor value indicates an ammonia concentration in the exhaust gas tract.

15. An internal combustion engine for a vehicle, the engine comprising:
a control device to control the internal combustion engine;
an inlet tract with a throttle valve;
a combustion chamber fed by the inlet tract;
an exhaust gas tract fed by the combustion chamber and having a catalytic converter;
wherein the exhaust gas sensor is arranged in the exhaust gas tract downstream of the catalytic converter;
wherein the control device is operable to detect a manipulation of a sensor value from the exhaust gas sensor by:
operating the internal combustion engine in an overrun cutoff mode;
determining a first sensor value from the exhaust gas sensor with the throttle valve closed;
establishing a suspected manipulation by the control device by evaluating the first sensor value as a function of a first threshold value; and
verifying the suspected manipulation using the control device by measuring a second sensor value from the exhaust gas sensor in the event of an increase in the emissions of the internal combustion engine and evaluating the second sensor value as a function of a second threshold value if the suspected manipulation has previously been established.
